(19) United States
(12) Patent Application Publication
(10) Pub. No.: US 2005/0023717 A1
(43) Pub. Date: Feb. 3, 2005

(54) Method for producing thermoplastic resin sheet

(75) Inventor: Yoshihiko Watanuki, Kobe-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED

(21) Appl. No.: 10/898,386

(22) Filed: Jul. 26, 2004

(30) Foreign Application Priority Data
Jul. 28, 2003 (JP) 2003-202260

(51) Int. Cl. B29C 47/00; B26D 1/06

(52) U.S. Cl. 264/148; 425/363; 425/308

(57) ABSTRACT

A thermoplastic resin sheet is produced by the method comprising the steps of heating a thermoplastic resin to be melted; extruding the melted resin through a die continuously into a sheet-like form to obtain a continuous thermoplastic resin sheet with a thickness of about 3 mm or more; and pressing at least one cutting blade against the continuous thermoplastic resin sheet so as to cut the sheet into pieces while transporting the continuous thermoplastic resin sheet in the extrusion direction.

### BACKGROUND OF THE INVENTION

1. Field of the Invention

The present invention relates to a method for producing a thermoplastic resin sheet.

2. Description of the Background Art

A thermoplastic resin sheet with a predetermined size has been produced using a thermoplastic resin in which, as shown in FIG. 4, thermoplastic resin (2) is firstly heat-melted; the melted resin is then extruded through die (D) continuously into a sheet-like form to obtain continuous thermoplastic resin sheet (3) (see, JP-A 2002-120249); and then continuous sheet (3) is cut into pieces with a predetermined length. In this method, continuous sheet (3) is cooled down sufficiently, while being transported in the extrusion direction from die (D), and then continuous sheet (3) is cut into pieces with a predetermined size with a rotary disc saw blade (C′) or the like, to provide a thermoplastic resin sheet (1). In cutting, the rotary disc saw blade (C′) or the like moves in the extrusion direction at the same speed as continuous sheet (3) transported, and moves at the same time in the direction at right angle to the extraction direction, carrying out the cutting. Consequently, thermoplastic resin sheet (1) as product is produced. After the cutting, rotary disc saw blade (C′) returns to the original position without contacting continuous sheet (3) in order to cut again continuous sheet (3) to produce another thermoplastic resin sheet (1).

In such a method, continuous sheet (3) is extruded through die (D) so as to have a thickness equal to that of the intended product, thermoplastic resin sheets (1). When rotary disc saw blade (C′) is employed, it is preferred to cut continuous sheet (3) after being sufficiently cooled down.

When thermoplastic resin (2) is heat-melted and extruded to prepare continuous sheet (3) with a thickness of about 2 mm at most, thermoplastic resin sheet (1) as a product can be continuously and easily obtained by cutting the continuous sheet (3) using a rotary disc saw blade (C′) even when a distance from die (D) to the original position of the rotary disc saw blade (C′) is short. This is because the continuous sheet (3) with a thickness of about 2 mm at most is cooled down in a relatively short time.

On the other hand, when thermoplastic resin (2) is heat-melted and extruded to prepare continuous sheet (3) with a thickness of about 3 mm or more, long distance (L) from die (D) to rotary disc saw blade (C′) is needed since it takes a long time to cool down continuous sheet (3), sufficiently. If the distance (L) is short, the continuous sheet (3) with a thickness of about 3 mm or more is cut while not being cooled down sufficiently and still being soft. As a result, cutting dust of thermoplastic resin (2) is easily attached to rotary disc saw blade (C′), and there is a possibility to roughen the resulting cut surface. When the distance (L) from die (D) to the original position of rotary disc saw blade (C′) is so long as to enable continuous sheet (3) to be cooled sufficiently, an apparatus for the production should be scaled up.

### SUMMARY OF THE INVENTION

The present inventor has enthusiastically conducted researches with the objects for developing a method for producing sheets having a thickness of about 3 mm or more continuously with ease using a compact apparatus. As a result, the present inventor has found that, by pressing a cutting blade against a continuous sheet so as to cut the sheet, the continuous sheet as extruded through a die can be cut continuously with ease even while not being cooled down, sufficiently. The present invention has been accomplished based on the findings.

The present invention provides a method for producing a thermoplastic resin sheet, the method comprising the steps of:

heating a thermoplastic resin to be melted;

extruding the melted resin through a die continuously into a sheet-like form to obtain a continuous thermoplastic resin sheet with a thickness of about 3 mm or more; and

pressing at least one cutting blade against the continuous thermoplastic resin sheet so as to cut the sheet into pieces while transporting the continuous thermoplastic resin sheet in the extrusion direction.

### BRIEF DESCRIPTION OF THE DRAWINGS

FIG. 1 is a schematic view showing an example apparatus for producing a thermoplastic resin sheet in the present invention;

FIGS. 2A to 2D are schematic views, each showing an example structure of cutting blades to be used in an apparatus for producing a thermoplastic resin sheet in the present invention;

FIG. 3 is a top plan view schematically showing a state where a cutting blade is pressed against a continuous sheet using an example apparatus for producing a thermoplastic resin sheet in the present invention; and

FIG. 4 is a schematic view showing an apparatus for producing a thermoplastic resin sheet by a conventional method.

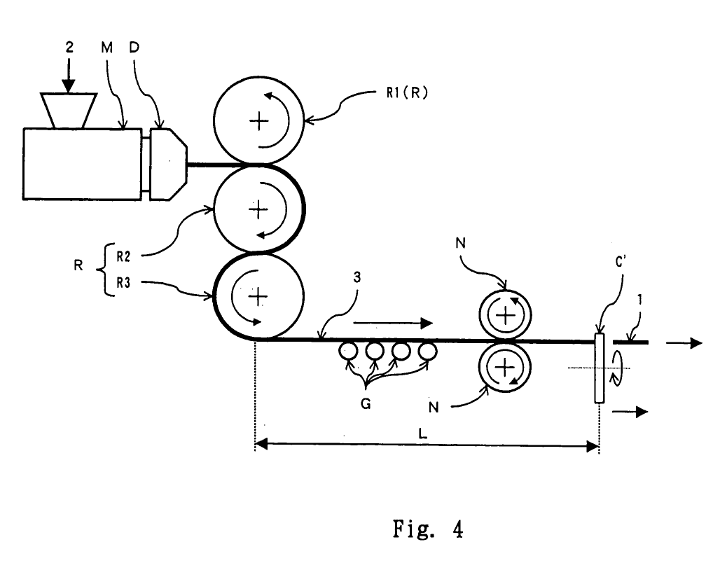

### DETAILED DESCRIPTION OF THE INVENTION

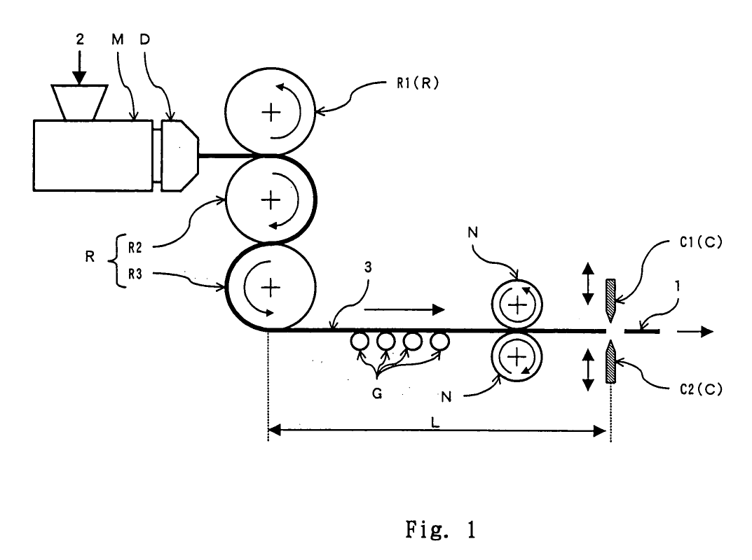

Referring to FIG. 1, an example embodiment of a method for producing a thermoplastic resin sheet and an apparatus to be used for the production in the present invention. The apparatus comprises:

die (D) through which thermoplastic resin (2) is extruded continuously into a sheet-like-form after the resin is heated and melted, to obtain continuous thermoplastic resin sheet (3) with a thickness of 3 mm or more;

calendar rolls (R) for transporting continuous thermoplastic resin sheet (3) in the extrusion direction; and

a set of cutting blades (C) for cutting continuous thermoplastic resin sheet (3).

Cutting blades (C) are allowed to be pressed against continuous thermoplastic resin sheet (3) so as to cut continuous thermoplastic resin sheet (3), while moving in the same direction at the same speed as those of the continuous thermoplastic resin sheet (3), which results in providing thermoplastic resin sheet (1). Then, the set of cutting blades (C) moves so as to open the blades and returns to the original position so as to cut again continuous sheet (3) to produce another thermoplastic resin sheet (1).

In accordance with the present invention, a continuous thermoplastic resin sheet with a thickness of about 3 mm or more is cut into pieces even in a state where the continuous sheet is not sufficiently cooled down after a thermoplastic resin (as a raw material) is heat-melted and extruded through a die continuously into a sheet-like form. As a result, a thermoplastic resin sheet having a thickness of about 3 mm or more and also having smooth cut surface can be produced continuously with ease. In addition, a long distance is not always needed from the die to the original position of a cutting means (for example, a saw, a blade or the like), thereby enabling the apparatus for producing the thermoplastic resin sheet to be compact. Moreover, since the cutting is performed by pressing at least one cutting blade against the continuous sheet, little cutting dust or burr tends to generate, resulting in providing excellent cut surface with the thermoplastic resin sheet having a thickness of about 3 mm or more.

In the present invention, thermoplastic resin (2) is heat-melted for prepare continuous thermoplastic resin sheet (3). Examples of thermoplastic resin (2) include methacrylic resin; a copolymer of methyl methacrylate and styrene (MS resin); polyolefin resins such as polyethylene (PE) and polypropylene (PP); polycarbonate resin (PC); polyvinyl resin (PVC); polystrene resin (PS) and the like.

In particular, the method for producing thermoplastic resin sheet (1) in the invention is preferably applied to the resins such as methacrylic resin, MS resin and the like. Such resins are excellent in transparency and are conspicuous when a cut surface is roughened. The resins to be preferably used in the present invention may have a relative large specific heat of about 0.3 cal/° C./g (about 1.26 J/° C./g) or more, and/or may have a relative small thermal conductivity in the range of about 4×10⁻¹ cal/sec/cm²/° C./cm to about 6×10⁻¹ cal/sec/cm²/° C./cm. Such resins are hard to be cooled. More preferably, the production method in the present invention is applied to hard methacrylic resin, hard MS resin and the like which contain no rubber component. Such resins are excellent in transparency and may have a Lockwell hardness in the range of about M 80 to about M 110.

Thermoplastic resin (2) may be heat-melted in a known manner using an extruder (M). For example, thermoplastic resin (2) is heated and kneaded in a melted state with the extruder (M), and is continuously fed to die (D). A heating temperature is a temperature of melting point of thermoplastic resin (2) or higher.

Heat-melted thermoplastic resin (2) is extruded into a sheet-like form through die (D), for example, at a speed in the range of about 10 m/min to about 30 m/min. A commonly-utilized T-die can be used as die (D). Die (D) may extrude thermoplastic resin (2) into a single layer structure, or may extrude thermoplastic resin (2) into a multilayer structure such as two-layer or three-or-more-layer structure. With the die for a single layer structure adopted, a single layer continuous sheet (3) can be obtained. With the die for a multilayer structure adopted, two or more kinds of thermoplastic resins can be co-extruded to obtain a multilayer continuous sheet (3). Since thermoplastic resin (2) is continuously fed from extruder (M) into die (D), thermoplastic resin is continuously extruded through the die.

A thickness of continuous thermoplastic resin sheet (3) extruded through die (D) may be about 3 mm or more, and may be about 20 mm or less. The method for producing a thermoplastic resin sheet in the present invention is preferably applied to the resin continuous sheet having a thickness of about 5 mm or more, and is more preferably applied to the resin continuous sheet having a thickness of about 7 mm or more. A width of continuous sheet (3) may be in the range of about 0.5 m to about 3 m. In the present invention, the cutting can be performed in a relatively high speed even when continuous sheet (3) has a large width, such as a width of about 0.5 m or more, and moreover a width of about 1 m or more, since continuous sheet (3) is cut with at least one cutting blades (C) being pressed against the continuous sheet (3).

Continuous thermoplastic resin sheet (3) may be cut by a set of cutting blades (C) as it is after being extruded through die (D). Alternatively, as shown in FIG. 1, continuous thermoplastic resin sheet (3), which has been extruded through die (D), may be rolled with calendar rolls (R), which may be then transported (conveyed) to a set of cutting blades (C) and then be cut by the blades. A diameter of calendar rolls (R) may be in the range of form about 15 cm to about 60 cm. When thermoplastic resin (2) extruded through die (D) is rolled with calendar rolls (R), the number of calendar rolls (R) is not limited as far as two or more rolls are included so that thermoplastic resin (2) is squeezed and rolled. In the apparatus shown in FIG. 1, three calendar rolls (R) are utilized. That is, thermoplastic resin (2) extruded through die (D) is firstly squeezed and rolled between a first calendar roll (R1) and a second calendar roll (R2), and then, while the rolled thermoplastic resin (2) is wound on the second calendar roll (R2), is again squeezed and rolled between the second calendar roll (R2) and a third calendar roll (R3).

In the present invention, continuous sheet (3) is transported in the extrusion direction. Transportation in the extrusion direction may be conducted in a way such that continuous sheet (3) is guided by a plurality of guide rolls (G) and, during the guidance, is drawn off by draw-off rolls (P) such as nip rolls. The continuous sheet (3) is cooled down during the transportation.

In the present invention, continuous sheet (3) thus obtained and transported is cut with at least one cutting blade (C) being pressed against continuous sheet (3).

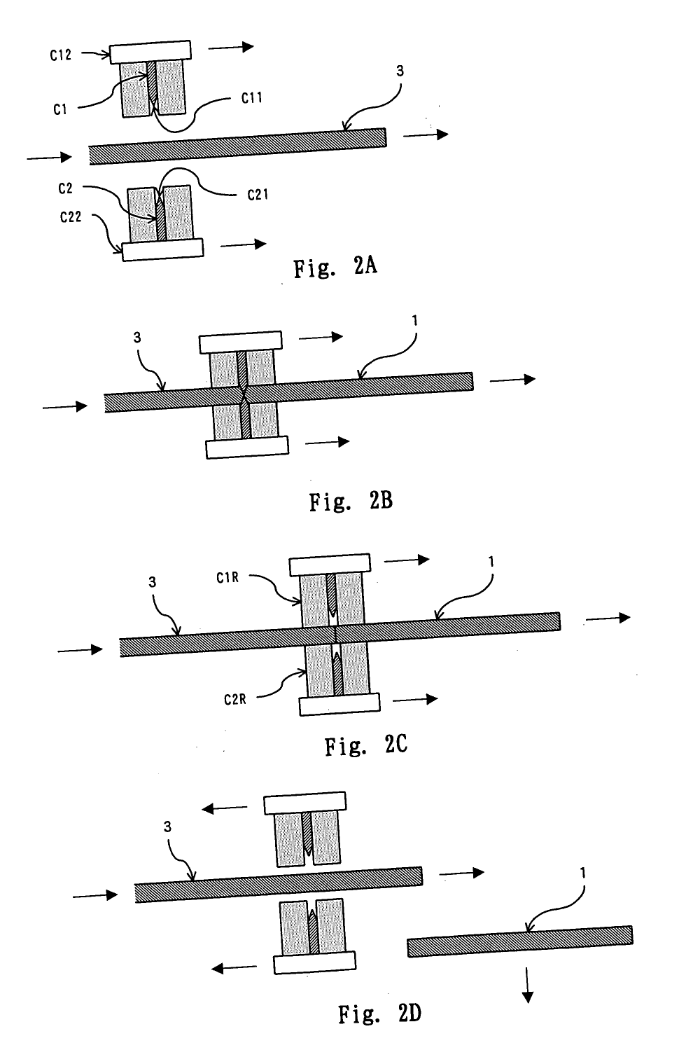

The number of cutting blade is not limited, and is appropriately decided depending, for example, on the thickness of the contituous sheet to be cut, the composition of the resin as a raw material for the sheet. The cutting blade may be commonly utilized blade. Referring to FIGS. 2A to 2D, one example of embodiments of the present invention is described below, in which a pair of cutting blades (C) are utilized.

In FIGS. 2A to 2D, a pair of cutting blades (C1, C2) are placed so as to face each other over the both sides of continuous sheet (3) (see, JP-A-7-285099 (1995)). The cutting blades are mounted on blade bases (C12, C22).

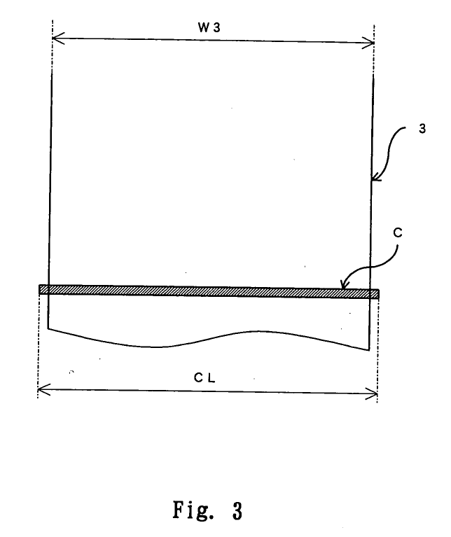

A blade length (CL) of cutting blades (C) may be nearly equal to or more than a width (W3) of continuous thermoplastic resin sheet (3), as shown in FIG. 3. When the blade length (CL) is less than width (W3) of the sheet, it may be difficult to cut the sheet by pressing the blades.

The cutting blades (C1, C2) move in the same direction and at the same speed as those of continuous sheet (3), as shown in FIG. 2A. While moving, cutting blades (C1, C2) move closer to each other so that the blades are pressed against continuous sheet (3). thereby cutting the continuous sheet (3) along the width direction as shown in FIG. 2B. The pressing of cutting blades (C1, C2) against continuous sheet (3) may be conducted by pressing cutting blades (C1, C2) through blade bases (C12, C22) using, for example, a press apparatus (not shown). When hard methacrylic resin, hard MD resin or the like is used as thermoplastic resin (2), cutting blade (C) may be laid to the resulting continuous thermoplastic resin sheet (3), causing the sheet (3) to be cracked and thereby cut in the thickness direction of the sheet (3).

Then, after the cutting, the upper and lower cutting blades (C1, C2), moves away from each other, as shown in FIG. 2C. Preferably, elastomers (C1R, C2R) are provided so that the elastomers are protruded from blade edges (C11, C12) on both sides of cutting blades (C1, C2) therealong, helping a sheet (1) be easily separated from cutting blades (C1, C2) by the action of resiliency of the elastomers.

After continuous sheet (3) is cut to prepare sheet (1), cutting blades (C) move away from the sheet (1), and then move in the direction opposite the extrusion direction of the continuous sheet (as shown in FIG. 2D) in order to be restored to the original position and to cut again continuous sheet (3) (as shown in FIG. 2A).

In accordance with the present invention, continuous sheet (3) is cut with at least one cutting blade (C) so as to have a smooth cut surface with little cutting dust or burr generated at the cut surface, to produce a thermoplastic resin sheet (1). The production method is preferred in producing sheets for optical applications such as a light transmitting plate assembled in a flat panel display of, for example, a liquid crystal display. Continuous sheet (3) is easily and continuously cut off with at least one cutting blade (C), even when continuous sheet (3) is not sufficiently cooled down and still has a relatively high temperature. Therefore, a distance (L) from die (D) to cutting blade (C) can be shortened, thereby enabling the apparatus for producing the thermoplastic resin (1) to be compact.

The invention being thus described, it will be apparent that the same may be varied in many ways. Such variations are to be regarded as within the spirit and scope of the invention, and all such modifications as would be apparent to one skilled in the art are intended to be within the scope of the following claims.

The entire disclosure of the Japanese Patent Application No. 2003-202260 filed on Jul. 28, 2003, indicating specification, claims, drawings and summary, are incorporated herein by reference in their entirety.

1. A method for producing a thermoplastic resin sheet, the method comprising the steps of:
heating a thermoplastic resin to be melted;
extruding the melted resin through a die continuously into a sheet-like form to obtain a continuous thermoplastic resin sheet with a thickness of about 3 mm or more; and
pressing at least one cutting blade against the continuous thermoplastic resin sheet so as to cut the sheet into pieces while transporting the continuous thermoplastic resin sheet in the extrusion direction.

2. An apparatus for producing a thermoplastic resin sheet, the apparatus comprising:
a die through which a heat-melted thermoplastic resin is extruded continuously into a sheet-like form to obtain a continuous thermoplastic resin sheet with a thickness of about 3 mm or more;
means for transporting continuous thermoplastic resin sheet in the extrusion direction; and
at least one cutting blade having a structure in which the at least one cutting blade is pressed against the continuous thermoplastic resin sheet to cut the continuous thermoplastic resin sheet while moving in the same direction at the same speed as those of the continuous thermoplastic resin sheet to be transported.
